(19) United States
(12) Patent Application Publication
(10) Pub. No.: US 2022/0051307 A1
(43) Pub. Date: Feb. 17, 2022

(54) SYSTEM FOR AND METHOD OF PROVIDING ITEM RECOMMENDATION WITHIN A CURATION SERVICE-BASED FRAMEWORK

(71) Applicant: SHEREE JANE GOTUACO, Manila (PH)

(72) Inventor: SHEREE JANE GOTUACO, Manila (PH)

(21) Appl. No.: 16/973,779

(22) PCT Filed: Jan. 22, 2020
(86) PCT No.: PCT/IB2020/050460

§ 371 Date: Dec. 10, 2020

(51) Int. Cl. G06Q 30/06; G06N 5/04

(52) U.S. Cl. CPC G06Q 30/0631; G06N 5/04; G06Q 30/0627; G06Q 30/0643

(57) ABSTRACT

The present invention is directed to providing at least one item recommendation within a computer-implemented curation service-based framework. The item recommendations are curated for a subject client and are of at least one size that suits an item of interest of the subject client for which a plurality of sizes is available. The subject client belongs to at least one group of subject clients. The group of subject clients is part of a plurality of groups of subject clients. Such item recommendations are caused to be presented to the subject client based on client specified data or client preferred data, item properties data corresponding to the item of interest of the subject client, and expert judgement data associated with any one or more of approval, rejection, and modification data from an expert in the field under which said item of interest of the subject client falls. The client may also approve item one or more item recommendations based on relevant information presented to him or her via a client computing device.

### TECHNICAL FIELD

The present invention relates generally to computer-based and/or computer-assisted implementations for electronically providing item recommendations and more specifically to providing such items recommendations within a curation service-based framework.

### BACKGROUND ART

The volume and diversity of information available over network-based systems or data communication infrastructure, such as the Internet, can easily overwhelm a person or a group of persons attempting to locate a desired piece of product, service, or a combination of both. There are times that these attempts result in frustrations.

For example, a person looking for a piece of clothing that suits his or her personal preferences, a piece of bedside table that fits his or her room relative to the size of his or her bed, or a set of tiles that is compatible with the existing design of the floor tiles installed in the flooring of his or her house can search the Internet, but is likely to either be confused by the volume and diversity of data that can be retrieved through various search engines. At the end of the day, such person may unable to locate any information that are relevant to his or her needs.

The ever-growing bandwagon of do-it-yourself product and service searching efforts has left Internet users with the problem of sorting and browsing through enormous amounts of data to locate information relevant to their preferences, needs, and priorities. Various targeted marketing services have been implemented using recommendation engines in an attempt to provide users with assistance and support for data inquiries in locating relevant information that typically include products and/or services. A successful recommendation service enables users to locate relevant information without wasting too much time and effort on fruitless searching endeavors.

Conventional recommendation services utilize collaborative filtering of user and/or item data to reduce the volume of information found through simple keyword searching or complex semantic searching. User-based collaborative filtering and item-based collaborative filtering are model-based algorithm for making recommendations. User-based collaborative filtering encompasses collection and processing of user behaviors. Item-based collaborative filtering, on the other hand, is for grouping similar items.

The most common information exchange platforms including various e-commerce sites can use item-based recommendations that use collaborative filtering to provide recommendations based on data supplied by a user or based on his or her purchase history. Item-based recommendations can also be applied to provide pre-organized and/or customizable group of items. However, collaborative filtering implemented in these information exchange platforms has severe shortcomings, especially when the specifications of items are added to the recommendation matrix. Attempting to provide a recommendation service without a touch of expertise further complicates the recommendation matrix.

Content curation services compensate for the shortcomings of existing electronic information exchange platform based recommendation services by providing functions that facilitate the search and classification of information, among others. However, while content curation services are focused on providing accumulated information over a certain period, it has been observed that many recommended items in possession of users are still rejected by users, or by groups of users, due to lack conformity to their exact, explicit, and sensitive requirements. There remains an outstanding need for implementations that can solve this problem.

### SUMMARY OF THE INVENTION

The present invention is directed to providing at least one item recommendation within a computer-implemented curation service-based framework. The item recommendation is for a subject client and is of at least one size that suits an item of interest of the subject client for which a plurality of sizes is available. The subject client belongs to a group of subject clients. The group of subject clients is part of a plurality of groups of subject clients. Consistent with other aspects of the invention, the method comprises various steps.

Firstly, an electronic request for item recommendations is received from the subject client, and in response to this item recommendations request, a set of specification parameters is provided. Each specification parameter in the set of specification parameters has a range of acceptable values.

The range of acceptable values for each specification parameter may then be received from the subject client. The range of values received from the subject client is processed as client specified data.

The next step is then to determine the group of subject clients to which the subject client belongs to retrieve from an item properties database system implemented in the curation service-based framework item properties data that are based on the client specified data. This step may be followed by analyzing the retrieved item properties data in connection with the client specified data to generate a filtered list of items with the plurality of sizes, and by presenting the filtered list of items to an expert from a plurality of experts in the field under which the item of interest of the subject client falls.

Consequently, any one or more of approval, rejection, and modification data may be received from the expert to generate expert judgement data. The expert judgement data correspond to expert judgement content.

If it is determined in the preceding step that the at least one item recommendation of at least one size that suits the item of interest of the subject client is to be made consistent with the client specified data, the item properties data, and the expert judgement data, the item recommendations are caused to be presented to the subject client using one or more electronic devices connected to a data communications network. The electronic device, such as a smart-phone, may be operated by the subject client.

The provision of providing item recommendation that takes into consideration vectors and feature vectors associated with client specified data, item properties data, and expert judgement data ensures that the actual, physical item corresponding to the recommendation conform to the subject client's exact, explicit, and sensitive requirements whereby chances and/or the rates of rejected items are considerably low, if none at all.

For a better understanding of the invention and to show how the same may be performed, preferred embodiments and/or implementations thereof will now be described, by way of non-limiting examples only, with reference to the accompanying drawings.

### BRIEF DESCRIPTIONS OF THE DRAWINGS

FIG. 1 is a block diagram showing example components implementable in the computer-implemented curation service-based framework of the invention.

FIG. 2 is a block diagram showing an example application of the curation service-based framework of the invention in the fashion and styling field.

FIG. 3 is a block diagram showing an example application of the curation service-based framework of the invention in the interior design field.

FIG. 4 is a block diagram showing an example application of the curation service-based framework of the invention in the building construction field.

FIG. 5 is a block diagram showing an example curation of content that can be implemented in the curation service-based framework of the invention consistent with one or more preferred implementations thereof.

FIG. 6 is a block diagram showing an example configuration of content with expert judgement data of the curation service-based framework of the invention.

FIG. 7 is a flow diagram showing an example process for constructing parameters in the curation service-based framework of the invention consistent with one or more preferred implementations thereof.

FIGS. 8 and 8A are connected flow diagrams showing an example manner of using the curation service-based framework by a subject client in accordance with one or more aspects and implementations of the invention.

FIG. 9 is a block diagram showing example hardware components and/or configuration of the curation service-based framework of the invention consistent with one or more preferred implementations thereof.

### DETAILED DESCRIPTION OF THE PREFERRED IMPLEMENTATIONS

All the ensuing disclosures and illustrations of the preferred implementations and/or embodiments of one or more aspects of the present invention, along with one or more components, features or elements thereof, are merely representative for the purpose of sufficiently describing the manner by which the present invention may be carried out into practice in various ways other than the ones outlined in the ensuing enabling description and specification of the present disclosure.

It is to be understood and appreciated, however, that the exemplary implementations used to describe how to make and use one or more aspects of the present invention may be embodied in many alternative forms and should not be construed as limiting the scope of the appended claims in any manner, absent express recitation of those features in the appended claims. All the exemplary drawings, diagrams, tables, formula, and illustrations accompanying the ensuing description should also not be construed as limiting the scope of the appended claims, as accompanied by this enabling description, in any manner.

Unless the context clearly and explicitly indicates otherwise, it is also to be understood that like reference numerals refer to like elements throughout the ensuing description of the figures and/or drawings of the present disclosure, that the linking term “and/or” includes any and all combinations of one or more of the associated listed items, that the singular terms “a”, “an” and “the” are intended to also include the plural forms, and that some varying terminologies of the same meaning and objective may be interchangeably used throughout the ensuing enabling disclosure of the present invention.

As may be used herein, unless otherwise specified, and consistent with one or more aspects and/or one or more implementations of the present invention, the term “framework” may generally refer to an application framework that provides for software library or a software framework that provides a generic code structure to support the development of reconfigurable applications for a computing environment or software platform that can be particularly built for efficiently, quickly, easily, and flexibly creating purposeful user interface applications enabling role-based data manipulations and application of business rules in various workflows, algorithms, processes and/or routines, wherein the application framework or the software framework is implemented using one or more hardware processors and their standard components.

As may be used herein, unless otherwise specified, and consistent with one or more aspects and/or one or more implementations of the present invention, the term “curation” may generally refer to selection, observation, collection, preservation, maintenance, organizing, integration, visualization, mapping, categorizing, inspecting, analyzing, interpreting, classifying, sorting, filtering, prioritizing, controlling, extracting, sharing, navigating, retrieving, contextualizing, recording and/or archiving of any number and type of electronic items or electronic media items corresponding to physical items.

As may be used herein, unless otherwise specified, and consistent with one or more aspects and/or one or more implementations of the present invention, the term “recommendation” refers to an electronically made suggestion to a subject client, aimed at matching the preferences, characteristics and/or attributes of the subject client, at satisfying the subject client, and at raising the interest of the subject client in one or more particular sets of items of interest, whether in digital format or as physical materials which correspond to one another.

As may be used herein, unless otherwise specified, and consistent with one or more aspects and/or one or more implementations of the present invention, the term “parameter” may refer to a measurable factor that forms part of a set that defines a system and/or sets conditions for operation of the same system. A parameter may be a numerical value, an alphanumerical value, a logical character, a graphical information, or any suitable range type that requires a unit of measure, although various examples are not so limited to such. Each of the plurality of parameters may be based on a corresponding characteristic of the plurality of characteristics. In some preferred examples, the plurality of characteristics may be the plurality of characteristics extracted from any one or more of the herein disclosed steps, processes, operations, tasks, fields, and system configurations.

As may be used herein, unless otherwise specified, and consistent with one or more aspects and/or one or more implementations of the present invention, the terms “connected to,” “connecting,” “communicating,” “in communication with,” “in operative communication with,” “interconnected,” or “interconnecting” may include direct connection/communication, indirect connection/communication and/or inferred connection/communication between devices/apparatuses/computers. The direct connection/communication may be provided through one or more hardware, software, firmware, electronic and/or electrical links between devices/apparatuses/systems. The indirect connection/communication may be provided through an intervening member such as a component, an element, a circuit, a module, a device, a node device, and an apparatus between or among devices/apparatuses/systems. The inferred connection/communication may be characterized by one device/apparatus/system being connected to or in operative communication with another device/apparatus/system by inference, and may include direct and indirect connections/communications.

It is to be understood and appreciated by a skilled person or a person having ordinary skills in the art to which the present invention belongs that the herein described modules are merely presented in segregated format based on their intended functions for the sake of illustrating how they are relevant to the implementations and/or aspects of the present invention. The herein described modules are merely illustrative and can be fewer or greater in number, as it is well known in the art of computing that such program codes representing various functions of different operably connected modules can be combined or segregated in any suitable but efficient manner.

As may be used herein, unless otherwise specified, and consistent with one or more aspects and/or one or more implementations of the present invention, the term “module” may refer to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable and re-configurable components or systems of components that provide the herein disclosed and/or described functionalities.

As may be used herein, unless otherwise specified, and consistent with one or more aspects and/or one or more implementations of the present invention, the terms “data communications network” may refer to any number of data communications systems including one or more of the following communications networks and/or frameworks: a public or private data network, a hybrid public and private data network, a wired or wireless data network, an IP (Internet Protocol) framework, a WLAN (wireless local area network), a WWAN (wireless wide area network), a GAN (global area network), a MAN (metropolitan area network), an LTE (Long Term Evolution) network of any generation such as 2G, 3G, 4G, 5G and 6G, a mobile WiMax (worldwide interoperability for microwave access) network, an enterprise intranet, and the like.

As may be used herein, unless otherwise specified, and consistent with one or more aspects and/or one or more implementations of the present invention, the terms “database system” may refer to or be characterized by MySQL (an open-source relational database management system), MongoDB (an open-source NoSQL database), PostgreSQL (an object-relational database management system (ORDBMS), or Redis (an in-memory database). Any standard XML (Extensible Markup Language) query language used by most XML databases may also constitute the database system in accordance with various aspects and implementation of the present invention.

As may be used herein, unless otherwise specified, and consistent with one or more aspects and/or one or more implementations of the present invention, the terms “software application” or “application” or “app” may refer to an emulated application or applet, to a web-based application, or to a mobile-based application, and may specifically refer to an executable computer software program or software application program that enables services and content associated with one or more implementations of the herein disclosed method, system, computer program product, intermediate system, further intermediate system comprising multiple intermediate systems, data stream, and data structure. The application may be a mobile app or any other application that is executable via any one or more of client computing devices via a server or via a network of computers. The program or programs which may constitute the application may be a self-contained software or is a component of or contained by another program or programs, any of which may be implemented by one or more hardware, software, firmware and/or cloud computing or cloud related computing resources comprising one or more infrastructure stacks and one or more infrastructure components such as application servers, file servers, directory servers, web servers, network servers, database servers, and the like.

As may be used herein, unless otherwise specified, and consistent with one or more aspects and/or one or more implementations of the present invention, the terms “client computing device” may refer to a wireless mobile or non-mobile data communication device such as a mobile phone, a smart-phone, a personal digital assistant (PDA) device, a tablet device, a phablet device, a desktop computer, a laptop computer, and the like. The client computing device may be connected to the herein disclosed data communications network and may access the herein disclosed curation service-based framework or platform. The client computing device may be used by a human client to gain access to the herein disclosed digital services, accessible via a network, of the present invention.

As may be used herein, unless otherwise specified, and consistent with one or more aspects and/or one or more implementations of the present invention, the term “processor” may refer to logic circuitry and/or processing core that is configured to implement computer programming instructions that cause an electronic device to perform various functions. Unless specifically stated otherwise, the term “processor” can refer to a single processing device or to multiple processing devices that together implement various steps of a process.

As may be used herein, unless otherwise specified, and consistent with one or more aspects and/or one or more implementations of the present invention, the terms “computer-readable medium” may refer to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computing device or computing system can read.

Likewise, unless otherwise specified, and consistent with one or more aspects and/or one or more implementations of the present invention, the terms “memory” or “memory system” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

As may be used herein, unless otherwise specified, and consistent with one or more aspects and/or one or more implementations of the present invention, the terms “instructions” and “codes” should further be interpreted broadly to include any type of computer-readable statement(s). For example, the terms “instructions” and “codes” may refer to one or more programs, routines, sub-routines, functions, procedures, etc. “Instructions” and “codes” may comprise a single computer-readable statement or multiple computer-readable statements.

It is also to be understood and appreciated that, in any portion or portions of the herein disclosure, the use of ordinal terms such as “first,” “second,” “third,” and so forth, is used herein to distinguish elements, features, components, calculations or steps from one another and should not also be construed as limiting the scope of the appended claims, and that these and such other ordinal terms that may appear in the ensuing description of the one or more aspects of the present invention are not indicative of any particular order of elements, features, calculations, components or steps to which they are attached. For example, a first element could be termed a second element or a third element. Similarly, a second element could be termed a first element or a third element. All these do not depart from the scope of the herein disclosure and its accompanying claims.

An aspect of the present invention is directed to a method of providing at least one item recommendation within a computer-implemented curation service-based framework that is accessible by a client using a client computing device and via a data communications network to which the curation service-based framework and the client computing device are connected. A web-based application or a mobile-based application, for example, can be executed on the client computing device to access the curation services and other related services configured in the curation service-based framework through or over the data communications network.

The item recommendation is for a subject client and is of at least one size that suits an item of interest of the subject client for which a plurality of sizes is available. The subject client belongs to at least one group of subject clients. The at least one group of subject clients is part of a plurality of groups of subject clients. The herein disclosed method aspect of the present invention comprises several steps that may be carried out by, performed by, or executed by one or more hardware processors of the herein disclosed curation service-based framework from one or more hardware memory systems thereof.

The first step of the method aspect of the present invention is characterized by receiving from the subject client an electronic request for item recommendations.

The second step of the method aspect of the present invention is characterized by providing a set of specification parameters, wherein each specification parameter that is included in the set of specification parameters has a range of acceptable values.

The third step of the method aspect of the present invention is characterized by receiving the range of acceptable values for each specification parameter, wherein the range of values are processed in the curation service-based framework as client specified data.

The fourth step of the method aspect of the present invention is characterized by determining the at least one group of subject clients to which the subject client belongs to retrieve from an item properties database system implemented in the curation service-based framework item properties data that are based on the client specified data or the data from the subject client.

The fifth step of the method aspect of the present invention is characterized by analyzing the retrieved item properties data in connection with the client specified data to generate a filtered list of items with the plurality of sizes. The sizes may be of any specification.

The sixth step of the method aspect of the present invention is characterized by presenting the filtered list of items to at least one expert from a plurality of experts in the field under which the item of interest of the subject client falls. The expert may use the herein disclosed web-based or mobile-based application to access the curation service-based framework, and through this application, the expert may be presented with the filtered list of items that substantially match the client specified data and/or client preferred data. The terms “client specified data” and “client preferred data” may be used interchangeably throughout the ensuing disclosure of the present invention.

The seventh step of the method aspect of the present invention is characterized by receiving any one or more of approval data, rejection data, and modification data from the at least one expert to generate expert judgement data. Here, the expert may or may not consult other experts and perform visual inspection, physically or virtually, of the subject client's item or items of interest.

The eight step of the method aspect of the present invention is characterized by causing to present to the subject client the at least one item recommendation if it is determined in the immediately preceding step that the at least one item recommendation of at least one size that suits the item of interest of the subject client is to be made consistent with the client specified data, the item properties data, and the expert judgement data.

An object of the present invention with respect to the herein disclosed aspects and implementations thereof is to provide highly reliable curation services using client specified data, item properties data, and expert judgement data from one or more experts. These services are preferably provided in an information exchange platform characterizing the herein disclosed curation service-based framework of the present invention.

Additionally, the herein disclosed aspects and example implementations of the present invention, in providing curated content with high reliability using client specified data, item properties data, and expert judgement data, generate feature vectors of the client specified content of the client and the expert judgement content, infer similarity by comparing the feature vectors between the client specified data and the item properties data, and infer further similarity by comparing the feature vectors between the client specified data and the expert judgement data. In one implementation, one or more experts may be assigned to each of the electronic request for item recommendations or to each subject client initiating such request in order to provide the subject client with personalized, timely, high-quality services.

In some implementations, and consistent with aspects of the present invention, expert-supported personalized recommendation services may be implemented for each field associated with the item of interest of the subject client. The expert-supported recommendation services in the herein disclosed framework may be used to achieve the above object.

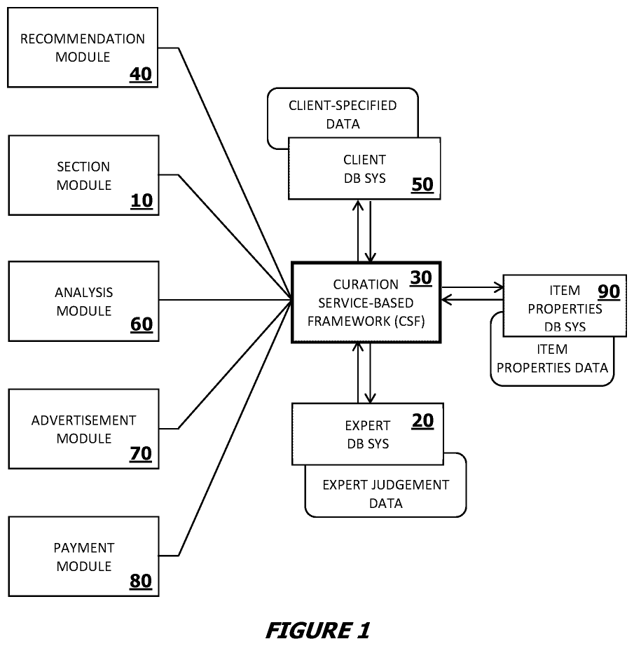

Referring now to FIG. 1, there is shown a block diagram which generally illustrates example components implementable in the computer-implemented curation service-based framework, which is now designated by reference numeral 30, of the present invention.

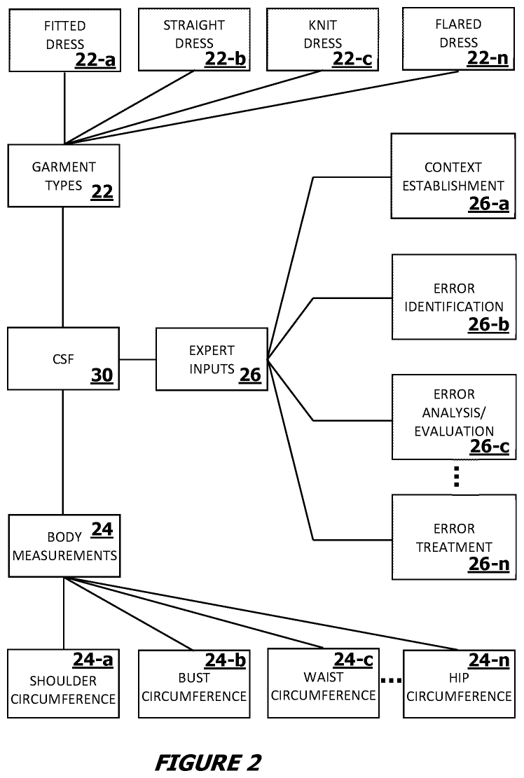

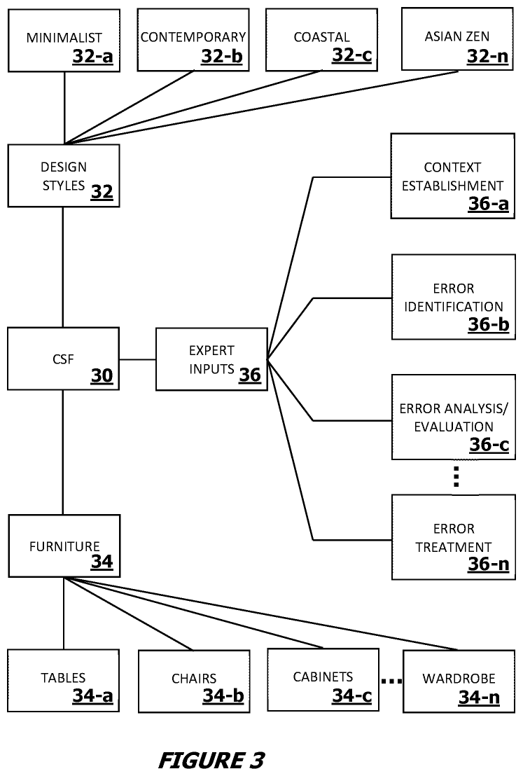

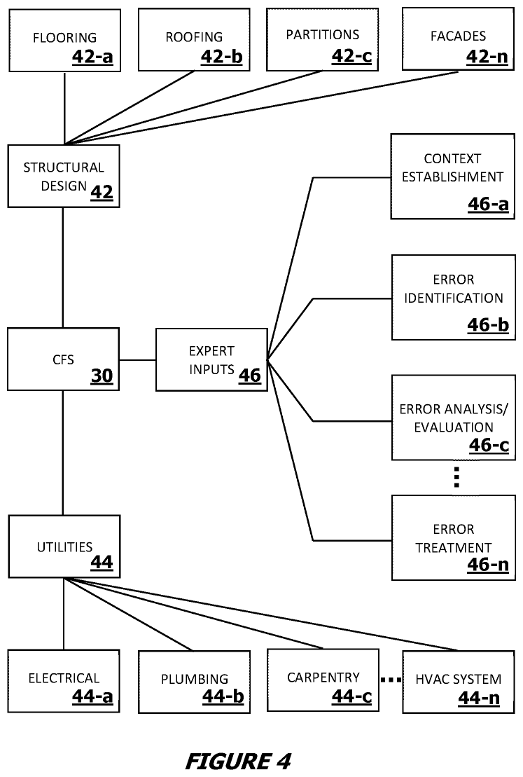

As shown in FIG. 1, the section module 10 is operably connected to the curation service-based framework 30 for constructing categories for each of the pre-divided sections based on computational epistemology modeling in each respective field or industry. For example, as shown in FIG. 2, the section module 10 may be configured to provide categories and sub-categories in the fashion and styling, e.g., in the corporate field. It should be understood however that any categories and sub-categories for any field and even for personalized item designs may be suitably used in conjunction with implementations of the present invention. In another example, as shown in FIG. 3, the section module 10 may be configured to provide categories and sub-categories in the interior design field. In yet another example, as shown in FIG. 4, the section module 10 may be configured to provide categories and sub-categories in the building construction field. It is to be understood and appreciated that any number and/or level of sub-categories may be configured using the herein disclosed section module 10.

By way of examples and not by way of limitations, as shown in FIG. 2 for the fashion and styling field, the curation service-based framework (CSF) 30 may be provided with main categories, which may be implemented as form fields, comprising garment types 22 and body measurements 24. The garment types 22 may have the sub-categories of fitted dress 22-a, straight dress 22-b, knit dress 22-c, and flared dress 22-n while the body measurements 24 may have the sub-categories of shoulder circumference 24-a, bust circumference 24-b, waist circumference 24-c, and hip circumference 24-n, depending on the type of garment corresponding to the specific item of interest of the subject client.

Data associated with garment types field 22 and its sub-fields 22-a, 22-b, 22-c, 22-n, and as well as with body measurement field 24 and its sub-fields 24-a, 24-b, 24-c, 24-n may be inputted into the curation service-based framework 30 as client specified data. These client specified data may then be matched with the item properties data previously loaded, preferably by a fashion expert, in the item properties database system 90 maintained in the curation service-based framework 30, consistent with aspects of the present invention. The recommendation module 40 may then provide the items recommendations based on this matching step. The initial item recommendations may then be reviewed by the assigned fashion expert so as to integrate the fashion expert inputs 26 that may come with context establishment 26-a, error identification 26-b, error analysis and/or evaluation 26-c, and error treatment 26-n, whenever applicable. In other words, the final item recommendation or recommendations may be determined based on the initial item recommendations that underwent review and evaluation rendered by the fashion expert.

By way of examples and not by way of limitations, as shown in FIG. 3 for the interior design field or industry, the curation service-based framework 30 may be provided with main categories, which may be implemented as form fields, comprising interior design styles 32 having sub-categories such as minimalist 32-a, contemporary 32-b, coastal 32-c, and asian zen 32-n, and also furniture 34 having sub-categories such as tables 34-a, chairs 34-b, cabinets 34-c, and wardrobe 34-n.

Data associated with design styles field 32 and its sub-fields 32-a, 32-b, 32-c, 32-n, and as well as with furniture field 34 and its sub-fields 34-a, 34-b, 34-c, 34-n may be inputted into the curation service-based framework 30 as client specified data. These client specified data may then be matched with the item properties data previously loaded, preferably by an interior design expert, in the item properties database system 90 maintained in the curation service-based framework 30, consistent with aspects of the present invention. The recommendation module 40 may then provide the items recommendations based on this matching step.

The initial item recommendations may then be reviewed by the assigned interior design expert so as to integrate the interior design expert inputs 36 that may come with context establishment 36-a, error identification 36-b, error analysis and/or evaluation 36-c, and error treatment 36-n, whenever applicable. In other words, the final item recommendation or recommendations may be determined based on the initial item recommendations that underwent review and evaluation rendered by the interior design expert such as an interior designer.

By way of examples and not by way of limitations, as shown in FIG. 4 for the building construction field, the curation service-based framework 30 may be provided with main categories, which may be implemented as form fields, comprising structural design 42 having sub-categories such as flooring 42-a, roofing 42-b, partitions 42-c, and facades 42-n, and also utilities 44 having sub-categories such as electrical 44-a, plumbing 44-b, carpentry 44-c, and heating, ventilation, and air conditioning (HVAC) system 44-n.

Data associated with structural design field 42 and its sub-fields 42-a, 42-b, 42-c, 42-n, and as well as with utilities field 44 and its sub-fields 44-a, 44-b, 44-c, 44-n may be inputted into the curation service-based framework 30 as client specified data. These client specified data may then be matched with the item properties data previously loaded, preferably by a building construction expert, in the item properties database system 90 maintained in the curation service-based framework 30, consistent with aspects of the present invention. The recommendation module 40 may then provide the items recommendations based on this matching step.

The initial item recommendations may then be reviewed by the assigned building construction expert so as to integrate the building construction expert inputs 46 that may come with context establishment 46-a, error identification 46-b, error analysis and/or evaluation 46-c, and error treatment 46-n, whenever applicable. In other words, the final item recommendation or recommendations may be determined based on the initial item recommendations that underwent review and evaluation rendered by the building construction expert who may be a civil engineer or a structural engineer.

As shown in FIG. 1, the herein disclosed aspects of the present invention may include an expert database system 20 for storing the professional contents corresponding to the expert judgement data and provided by one or more experts in each field. A client database system 50 may also be provided in the herein disclosed aspect of the present invention, and the client database system 50 may be used for storing personalized contents corresponding to the client specified data. Furthermore, the item properties database system 90 may be provided in the herein disclosed aspects of the present invention, and the item properties database system 90 may be used for storing pre-determined specification contents corresponding to the item properties data.

Using character strings extracted from each of the stored client specified data, item properties data, and expert judgement data, the same data may be classified to correspond to one or more categories according to a pre-determined criterion or two or more pre-determined criteria. The curation service-based framework 30 may also be used to assign each expert having the professional capability to render relevant advices and consequently generate expert judgement data based on the initial item recommendations which resulted in the matching of the client specified data and the item properties data. The text extracted from the client specified data for the fields 22, 24, 32, 34, 42, 44, for example, may be compared with the text extracted from the item properties data to calculate the similarity of and/or difference between the client specified data and the item properties data.

Using the result of the calculation of such similarity and/or difference, i.e., comparison, the recommendation module 40 may provide the initial item recommendations for the subject client, wherein the initial item recommendations are of sizes and/or specifications that suit the item of interest of the subject client for which a plurality of sizes or specifications is available.

The assigned expert in each field may access the curation service-based framework 30 to retrieve such comparison result and the initial item recommendations. The client specified data based on the content created in the client database system 50 may be reviewed by the expert to ensure that all values supplied by the subject client are within the range of acceptable values that can be found in the item properties data. In the method aspect of the present invention, and consistent with other aspects and various implementations thereof, the analyzing of the retrieved item properties data includes at least one tolerance value associated with the item of interest of the subject client and defined by the client specified data representing the range of acceptable values for each specification parameter.

Accordingly, and consistent with various implementations of the present invention, the at least one tolerance value defines a range of acceptable differences between a first measurement from the client specified data and a second measurement from the item properties data, wherein a physical item corresponding to the at least one item recommendation has dimensional measurements that fall within the at least one tolerance value. By way of examples and not by way of limitation, the following table illustrates client specified size for a certain parameter such as waist measurement for an item of interest that is characterized by a stretchable pair of pants or any similar fashion and styling related item, tolerance value for the type of the item of interest, and the recommended sizes taking into consideration the tolerance value.

| CLIENT | | | |
|---|---|---|---|
| SPECIFIED | ITEM | TOLERANCE | RECOMMENDED |
| VALUE | MATERIAL | VALUE | SIZE |
| 36.0 | COTTON | −0.5 | 35.5 |
| | SATEEN | | |
| | STRETCH | −1.0 | 35.0 |
| | DENIM | | |
| | NON-STRETCH | 0 | 36.0 |
| | DENIM | | |

In an implementation, the client database system 50 may store the professional judgement content, the recommended expert information, and the professional judgement content of the recommended expert in any order or by following a specific, pre-determined sequence. A list of professional judgement content of the recommended expert among pluralities of the professional judgement content may be stored in the analysis module 60 according to implementations of the present invention.

The advertisement module 70, in operative communication with the expert database system 20, may be configured to provide advertisement information of the content related to the client specified content of the client. All content and advertisement information related to the implementations of various aspects of the present invention may be caused to be displayed using a display module (not illustrated). All payments made in relation to purchasing of the recommended item(s) in the herein disclosed curation service-based framework 30 may be processed using the payment module 80. A built-in payment form connected to a payment gateway may be implemented in the curation service-based framework 30. Alternatively, the processing of such payment may require the subject client to use an external resource or external internet link for the payment gateway.

In an implementation, the section module 10 may be configured to build a category for each of the pre-divided fields based on computational epistemology modeling. Computational epistemology is a conceptual model that expresses the consensus of people's discussions about what they see, hear, feel and think about the world in a conceptual and computer-implementable form. “Computational epistemology” may also refer to the computational processes implied or required to achieve human knowledge. It can be included in that category the artificial intelligence, the supercomputers, the expert systems, the distributed computation, the imaging technologies, the virtual instruments, the middleware, the robotics, the grids, or the databases (Segura, 2009).

Since this computational epistemology represents knowledge that has been agreed upon, preferably by a group of experts or professionals, it is not limited to any individual but a concept agreed upon by all members and/or experts belonging to one particular group. In computer science and information science, this is a data model representing a specific domain and is defined as a set of formal vocabulary describing the concept and the relation between the concepts belonging to a specific domain, for example, in the domain of fashion.

In an implementation, the section module 10 may be configured to build a category for each field divided in advance based on computational epistemology modeling and professional judgement content, raw data and/or information possessed by the experts or professionals. Using the newly extracted text from the expert database system 20 and pre-configured the expert contents stored in the same expert database system 20, the stored expert contents may be classified to correspond to the category according to a preset criterion, and expert information associated with expert generated contents may be stored.

The category and the text extracted from the client specified content of the specific field chosen by the client and the text extracted from the professional judgement content may be calculated to calculate the similarity and recommend experts based on the degree of similarities among the professional or expert judgement contents or data. The expert judgement content or data stored may also be caused to be stored in the recommendation module 40 and in the expert database system 20, from which the display module may cause to display a list of the recommended expert judgement content and/or a list of experts qualified to render such expert judgement content or expert judgement data accordingly.

According to an implementation of the present invention, the expert database system 20 may include an expert information repository for storing the expert information, a professional judgement content repository for storing the expert contents possessed by the expert, and a content classifier from the professional judgement content. The curation service-based framework 30, in this regard, may include a feature vector storage for storing the feature vector for feature information extracted from the database systems 20, 50, 90. The curation service-based framework 30 of the present invention may also include an apparatus that may further include a central database system configured to store the contents created by the client, the recommended expert information, and the professional judgement content of the recommended expert, and the content created from the client stored in the client database system 50, the recommended expert information, and the items recommendations.

In one implementation, the curation service-based framework 30 may include the analysis module 60 that extracts the client specified content of the clients based at least in part on the expert's professional judgement content, or based at least in part on the item properties data or item properties data, or a combination thereof. The recommendation module 40 according to a preferred implementation of the present invention may recognize the category to which the recommended expert is assigned, recommends at least one expert belonging to the category to which the recommended expert is assigned, and generates item recommendations from the professional judgement content. The professional judgement content feature vector and the client specified content feature vector extracted from the client specified content of the specific field selected by the client may be compared with one another so as to infer degree of similarities and/or differences for that matter, and consequently to provide curated item recommendations for the subject client.

In some implementations, the herein disclosed content may form a group among the same clients, and recognizes the group to which the client belongs, and recommends at least one expert from a pool of experts assigned to that group to which the client specified content belongs. For example, without limitations, the groups of subject clients may include employees of a company, wherein the company requires unique uniform for each level of employees. The employee level could be, by way of examples, rank and file employees, supervisory and managerial employees, and executive employees.

In one provisional implementation, the expert may be added through an expert recruitment module (not illustrated) that can be used to search for and recruit various experts by analyzing the contents associated with profiles and registration information of experts. The expert recommendation process, according to the present invention, may be implemented such that the objects of the present invention may be achieved.

The expert recommendation process may comprise (a) establishing a category for each sector divided in advance based on computational epistemology modeling, and a data storage step of storing professional judgement contents held by experts in each field in the expert database system 20; (b) classifying each of the stored professional judgement content to correspond to the category according to a predetermined criterion by using text extracted from each of the professional judgement content stored in the expert database system 20; and (c) assigning each expert having the capabilities to render professional judgement content to the concerned category. In an implementation, the herein disclosed expert selection step and the selection sub-steps for selecting the expert may be implemented using the professional judgement content and by calculating the similarity between the strings of characters extracted from the client specified content of the specific field chosen by the client and the strings of character extracted from the expert judgement content previously or currently rendered by the expert.

Consistent with one or more aspects and implementations of the present invention, identifying the category to which the assigned expert is assigned may be implemented using any suitable expert recognition step characterized by identifying other experts belonging to the category to which the selected expert is assigned, and identifying such other experts belonging to the category or parameter to which the selected expert is assigned. A client identification step may be implemented by way of extracting client specified content based on the herein disclosed recommendation processes or routines and the content curated from the subject client, the recommended expert information, and as well as the professional judgement content of the recommended expert.

The expert-based, personalized recommendation services for each field and the expert recommendation routines, according to various implementations for providing at least one item recommendation within the herein disclosed computer-implemented curation service-based framework 30 of the present invention, provide more accurate and reliable information. These services and routines are particularly achieved by providing curated contents which undergo expert verification in providing information through the herein disclosed electronic curation service-based framework 30. The curated content can be provided with high reliability, less if not zero error, and less if not zero occurrence of returned items due to mismatch of item specifications provided by client and standard and/or customized specifications of the item of interest of the client. A feature vector of the client specified content of the client and the expert content may processed and/or generated such that the similarity between them is inferred. This inference can be achieved, for example, by way of comparing the feature vector between the client specified content/data and the professional judgement content/data. When the degree of similarity of the feature vector is high, it means that items recommendations are highly reliable and vetted against the specific needs, requirements, and specifications of subject clients.

It is to be understood and appreciated that such inference may be derived from the item properties data that are considered by the herein disclosed algorithms or processes as the “closest preferred fit” with respect to, or in relation to, any one or more of the client specified content/data and professional judgement content/data. It should be noted that the terms “content” and “data” may be interchangeably used throughout the present disclosure, and the same is the case with the terms “professional” and “expert,” with the terms “specifications” and “parameters,” and finally with the terms “recommendation” and “closest preferred fit.”

It is to be understood and appreciated that the term “curation” may specifically be used as a collective term for collection list management, interpretation, exhibition, and propagation of collections of content from various sources, wherein each content represents a real-word item such as a dress in the fashion and styling industry, a piece of furniture in the interior design industry, and a piece of structural material in the building construction industry. The importance of human intelligence in conjunction with computer-assisted implementations in collecting, interpreting, and distributing relevant information for curation purposes is hereby highlighted, and it may hence be used in a broader sense beyond the scope of art.

The herein disclosed expert-based personalized recommendation services for each field according to various aspects of the present invention are provided by means of an electronic platform. Arranged in this platform are the published contents which can be accessed to registered users of the herein disclosed curation service-based framework 30, and these users, depending on their respective roles and/or administrative functions, can curate the published contents, and the curated contents are stored in any of the herein disclosed database systems or central database system. In some implementations, clients may be able to view the curated contents of based on his or her item of interest and/or the curated contents based on the items of interests of other subject clients. Subject clients may also view the various categories built for each field based on the computational epistemology according to the present invention, examples of which are illustrated in FIGS. 2, 3 and 4 for the fashion and styling, interior design, and building construction fields.

In an implementation, the section module 10 builds the categories by fields. These fields may be provided with various data (e.g., client specified data, expert judgement data, and item properties data) using a software application that can be accessed through the Internet which may be, by way of examples, mobile Internet, optical Internet, wireless Internet, and next-generation Internet-like communication structure. Exchange of data may also be performed through the herein disclosed curation service-based framework or platform 30.

In some implementations, the expert database system 20 may be implemented as database subsystems that may or can include (a) an expert information repository for storing the expert information, (b) a professional judgement content repository for storing the expert contents generated by and through the expert, (c) a content classifier from the professional judgement content, and (d) a feature vector storage for storing a feature vector extracted from the features of any one or more of the client specified content, item properties content, and expert judgement content.

The content classifier may be configured to analyze the professional or expert judgement content stored in the expert database system 20 based at least in part on the extracted keyword, i.e., by extracting a keyword based on the strings of each of the professional judgement content stored in the expert database system 20. The content classification may be performed to correspond to the category. An expert corresponding to the classified professional judgement content may be assigned to each category configured through the use of the herein disclosed computational epistemology-based fields. In an implementation, the herein disclosed curation service-based framework 30 may be provided with an artificial intelligence (AI) component through which previously gathered client specified data may and can be used to generate future item recommendations.

In an implementation, the recommendation module 40 may be configured to extract a keyword based on the strings of each of the client specified content of the specific field that the client accesses, and to further extract a keyword based on the strings of the professional judgement content. The similarity between these two keywords may be calculated by comparing the keyword extracted from the client specified content with the keyword extracted from the professional judgement content. Through this and such other similarly arranged configurations, item recommendations may come from results with highest degree of similarity among the client specified data/content and expert judgement data/content. In addition, the feature content vector stored in the feature vector repository and the content classifier may be used to compare the client specified content feature vector extracted from the feature content of the client specified content from the strings of the client specified content in the specific field used by the client. With this, a plurality of the items recommendations may be presented in an order characterized by such similarities, differences, or “closest preferred fit” most specifically. It is to be understood and appreciated that the term “keywords” may refer to at least one or any suitable combination of categories and measurements or properties of items.

The client database system 50 may be configured to store the contents created by the client, the recommended expert information, and the professional judgement content of the recommended expert. Through this, the analysis module 60 may extract the client specified content of the clients based on the contents created from the client stored in the client database system 50, the recommended expert information, and the professional judgement content of the recommended expert or professional. In addition, and consistent with various aspects and implementations of the present invention, the recommendation module 40 may be used to form a group between the clients with the same client specified content, recognizes a category belonging to the client specified content, and recommends at least one expert among the experts and professionals assigned to the category belonging to the client specified content.

In an implementation, the advertisement module 70 may be configured to provide advertisement information of content for an area or field related to client specified content of clients. The advertisement module 70 may use the relevant information related to the group of clients “X,” the group of clients “Y,” and the group of clients “Z,” and the mixed knowledge through the association context for the region of interest may be used to generate advertisement data that are related to attributes of each of the groups of clients “X,” “Y,” and “Z.”

Meanwhile, in an implementation, the expert may be added through the expert recruitment module that can be used for searching for and recruiting experts. The expert recruitment module searches each concept existing in the computational epistemology, and then an invitation mail may be sent to the searched experts through e-mail, thereby registering the experts who respond to the invitation. Through these registered experts, assignment of experts to different tasks which require different knowledge and expertise may be efficiently performed.

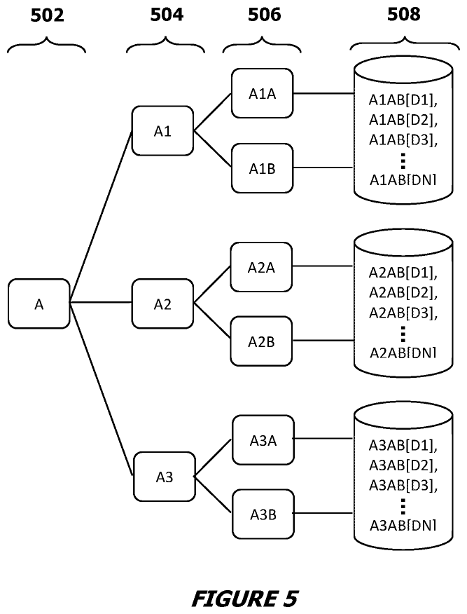

As shown in the block diagram of FIG. 5, which shows an example curation of content that can be implemented in the curation service-based framework 30 of the present invention consistent with one or more preferred implementations thereof, the expert-based or expert-assisted personalized recommendation services provided for by the herein disclosed curation service-based framework 30 for each category exemplary presented throughout the entire enabling disclosure of the present invention may include the following representative fields, A, A1, A2, A3, A1A, A1B, A2A, A2A, A3B:

| | | Measurement | Recommended |
|---|---|---|---|
| Main Field | Sub-Fields | Data | Items |
| A | A1 | A1A | A1AB[D1] . . . |
| (Department | (executive | (measurements | A1AB[DN] |
| of Trade and | employees) | for tops) | (uniform of |
| Industry) | | A1B | various designs |
| | | (measurements | and/or sizes) |
| | | for bottoms) | |
| | A2 | A2A | A2AB[D1] . . . |
| | (managerial and | (measurements | A2AB[DN] |
| | supervisory | for tops) | (uniform of |
| | employees) | A2B | various designs |
| | | (measurements | and/or sizes) |
| | | for bottoms) | |
| | A3 | A3A | A3AB[D1] . . . |
| | (rank and file | (measurements | A3AB[DN] |
| | employees) | for tops) | (uniform of |
| | | A3B | various designs |
| | | (measurements | and/or sizes) |
| | | for bottoms) | |

The main field 502 may be the company that is interested in having the uniform of their employees made and delivered to them using the herein disclosed curation service-based framework 30. The main field 502 maybe manually supplied by the subject client, may be automatically detected and attributed to the client upon log in to the platform implementing the herein disclosed curation service-based framework 30, or through a selection such as by way of a drop-down menu. The sub-fields 504, which represent groups of subject clients or users, may be characterized by the level of employees. Similarly, the sub-fields 504 maybe manually supplied by the subject client, may be automatically detected and attributed to the client upon log in to the platform implementing the herein disclosed curation service-based framework 30, or through a selection such as by way of a drop-down menu or any similar selection scheme.

Meantime, the measurement data 506 may be supplied by the subject client with or without assistance of an expert. If with assistance of an expert, a video conference between the client and the expert may be conducted inside or outside of the curation service-based framework 30 in order for the expert to assist the client in obtaining measurements in a proper manner and with accuracy based on industry standards. In an implementation, the manner of properly obtaining body measurements of various parts of the body based on one or more items of interest in the fashion and styling industry may be uploaded in the platform implementing the curation service-based framework 30 as a video tutorial or video materials containing elaborated instructions, as information graphics, or as text-dependent manual. The initial item recommendations 508 resulting from this curation may then be provided as shown in FIG. 5.

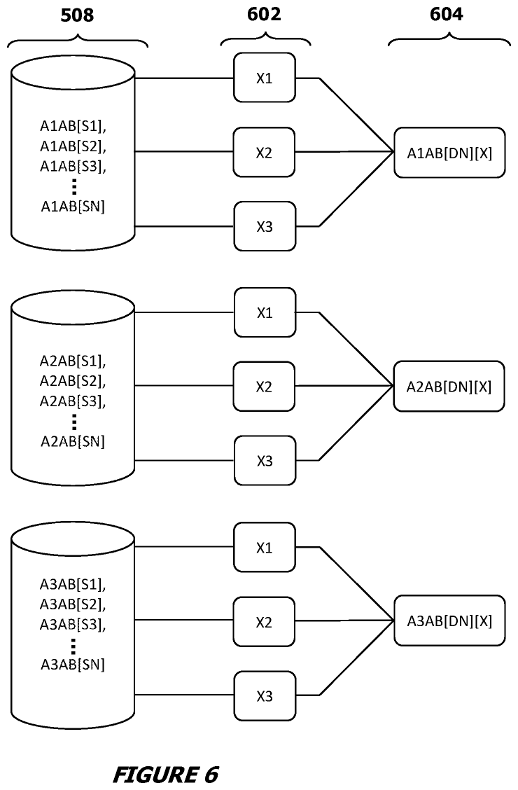

As now shown in FIG. 6, the initial item recommendations 508 may be reviewed by one or more experts, wherein one or more expert judgement data 602 may be generated. These data may include additional data, subtracted data, or any arrangement of modified data if need be. The final item recommendation or recommendations 604 as the case may be may finally be generated after the expert judgement data are factored into the initial item recommendations. Each of the final item recommendations 604 may be considered as the “closest preferred fit,” as may be disclosed herein.

The final recommended items or item recommendations 604 are the results of the curations that factored in the requirements of the company for uniforms such as pre-agreed designs and fits, the employee level of each subject client, the relevant measurement data required for manufacturing the uniforms, and the expert judgement data. In one implementation, the client-employee may choose or select from the items recommendations 604 which may come with various designs and sizes that fit his or her requirements based on the herein disclosed computing epistemology. In another implementation, the client-employee may not be able to choose specific content, e.g., specific design of a uniform, as the company he or she is working for has already pre-selected it. Consistent with the method and other aspects of the present invention, at least one selection of item recommendation 604 from at least one item recommendation 604 may be received from the client.

While the measurement field or data 506 as shown in FIG. 5 may constitute the herein disclosed specification parameters, it is to be understood and appreciated that such parameters are not limited to measurements of body part in the case where the items of interest belong to the fashion industry. Such parameters may include fabric type, gender, fit type, and the like—if these parameters are not predetermined by the company which requires the uniforms for their employees of various levels.

Consistent with various aspects and implementations of the present invention, the herein disclosed method aspect thereof may further comprise further steps characterized by receiving from the subject client an electronic purchase request for at least one physical item corresponding to the received selection, initiating an electronic purchase transaction process based on the purchase request, completing the electronic purchase transaction process by connecting to a payment gateway, storing in a transaction history database the presented at least one item recommendation, and storing in a transaction history database implemented in the curation service-based framework 30 the at least one item recommendation that is presented to the subject client.

In an alternative implementation, the costs of curation services and the predetermined number of recommended, selected items may be covered by the company, which means that such services and predetermined number of items may be provided for free. However, it could be provisioned that additional items may be purchased by the subject clients on their accounts if they so desired. In another provision, if the material of a subject client's choosing costs more than what is covered by the company, then he or she can still purchase the item made out of that material with the difference in the cost deducted from his or her monthly salary or covered by him or her through different modes of payment such as cash, debit, credit, check, prepaid, or the like.

Meanwhile, the professional judgement content stored in the expert data repository may be inputted to the content classifier to generate a corresponding feature vector. In addition, the generated professional judgement content feature vectors may be stored in the feature vector repository of the central database system.

In an implementation, comparing the similarity between the feature vector of the accumulated client specified content stored in the client database system 50 and the expert content feature vector of the expert stored in the expert database system 20 may result either in the initial or final item recommendation or recommendations.

In some implementations, different experts may render the expert judgement content associated with the fields A1, A2, A3 and curated content associated with fields A1A, A1B, A2A, A2B, A3A and A3B. In addition, the client may supply the client specified data by himself or herself and modify them using the contents related to the example fields A1A, A1B, A2A, A2B, A3A and A3B.

Therefore, the present invention extracts a feature vector through keywords from the initially curated contents A1AB[D1], A1 AB[D2], A1 AB[D3], . . . A1AB[DN], A2AB[D1], A2AB[D2], A2AB[D3] . . . A2AB[DN], A3AB[D1], A3AB[D2], A3AB[D3], . . . A3AB[DN] to generate final item recommendations A1AB[DN][X] which may include A1 AB[DN][X1] . . . A1AB[DN][XN], A2AB[DN][X] which may include A2AB[DN][X1] . . . A2AB[DN][XN], and A3AB[DN][X] which may include A3AB[DN][X1] . . . A3AB[DN][X], according to some implementations.

In some implementations, the expert judgement data may be treated as feature vectors. By extracting feature vectors through the keywords, the initially curated contents A1 AB[D1], A1 AB[D2], A1AB[D3], . . . A1AB[DN], A2AB[D1], A2AB[D2], A2AB[D3] . . . A2AB[DN], A3AB[D1], A3AB[D2], A3AB[D3], . . . A3AB[DN] may be analyzed and compared with features vectors extracted from the client specified data. Through this, the degree of similarity, or in in effect the degree of difference as well, between the client specified content feature vectors and the professional judgement content feature vectors of the system may be determined with high degree of accuracy.

According to various implementations of the present invention, the degree of similarity between feature vectors extracted from client specified content and feature vectors extracted from the item properties content may be determined. The degree of similarity between feature vectors extracted from initial item recommendations and feature vectors extracted from the expert judgement content may also be determined accordingly.

The resulting degrees of the similarities may be used for generating the final item recommendations. In an implementation, the similarity between the feature vectors extracted from the curated expert judgement content in the case of multiple experts rendering several expert judgement contents and the feature vectors extracted from the curated initial recommendations may be used to rank item recommendations quantitatively determined in an order from highest to lowest degrees of similarities among feature vectors. It is to be understood and appreciated that the herein disclosed “item” may be representative of a physical item or an actual deliverable service.

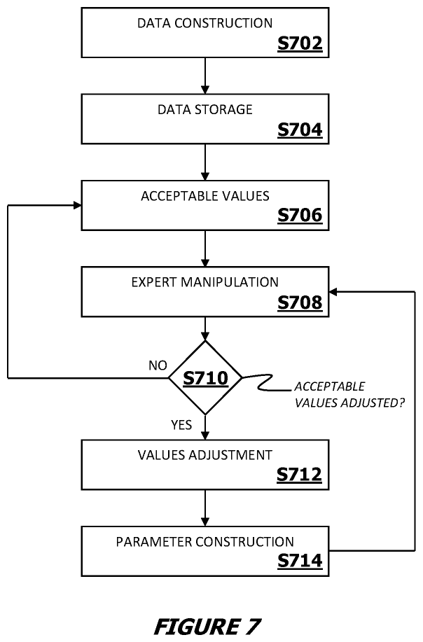

Referring now to FIG. 7, there is shown a flow diagram showing an example process for constructing parameters in the curation service-based framework 30 of the present invention. Data construction is the first step (S702). This first step may also be characterized by an expert selection step since the data that can be used for the parameter construction may be performed preferably based on the inputs from one or more experts. For example, in the fashion and styling field, a fashion and styling expert may set these parameters.

The set of parameters for the garment type in the fashion and styling industry may include, but not limited to, fitted dress, straight dress, knit dress, fitted jacket, straight jacket, knit jacket, fitted top, straight top, knit top, fitted skirt, straight skirt, fitted pants, straight pants, overalls, fitted coat, and straight coat.

The set of parameters for the measurements of some body parts in the fashion and styling industry may include, but not limited to, shoulder circumference, bust circumference, waist circumference, hip or high hip circumference, shoulder to shoulder front, bust front, waist front, high hip front, hip front, shoulder to bust height, shoulder to waist height, shoulder to high hip height, shoulder to hip height, shoulder to hem height, waist to hem height, center front to hem height, center back to hem height, outseam, total rise, armhole circumference, inseam, sleeve length, neck to shoulder, front rise, thigh circumference, and bottom of leg circumference.

The above mentioned example data for the data construction step may be stored in the data storage step (S704). The acceptable values may then be set at the succeeding step (S706). The curation services for implementation and execution through the herein disclosed curation service-based framework 30 have no size or specification limitations practically speaking. The sizes of the recommended items may be of any specification and may have a broad range to accommodate a wide of requirements of subject clients. The expert may then manipulate the values in accordance with industry standards (S708). If such values, or ranges of such values, are acceptable as determined in the subsequent decision step (S710), the values may be adjusted (S712). Otherwise, the process may move back to step S706. The final step is parameter construction (S714) which, partly or wholly, may be based on the expert manipulation.

Another aspect of the present invention is directed to a system for providing at least one item recommendation within a computer-implemented curation service-based framework 30. The item recommendation is for a subject client and is of at least one size that suits an item of interest of the subject client for which a plurality of sizes is available. The subject client belongs to at least one group of subject clients. The at least one group of subject clients is part of a plurality of groups of subject clients. The system aspect of the present invention comprises (a) a processor; and (b) a tangible, non-transitory memory configured to communicate with the processor, wherein the tangible, non-transitory memory has instructions stored thereon that, in response to execution by the processor, cause the processor to perform various operations.

The first operation of the system aspect of the present invention is characterized by receiving from the subject client an electronic request for item recommendations.

The second operation of the system aspect of the present invention is characterized by providing a set of specification parameters, each specification parameter in the set of specification parameters having a range of acceptable values.

The third operation of the system aspect of the present invention is characterized by receiving the range of acceptable values for each specification parameter, the range of values being processed as client specified data.

The fourth operation of the system aspect of the present invention is characterized by determining the at least one group of subject clients to which the subject client belongs to retrieve from an item properties database system implemented in the curation service-based framework item properties data that are based on the client specified data.

The fifth operation of the system aspect of the present invention is characterized by analyzing the retrieved item properties data in connection with the client specified data to generate a filtered list of items with the plurality of sizes.

The sixth operation of the system aspect of the present invention is characterized by presenting the filtered list of items to at least one expert from a plurality of experts in the field under which the item of interest of the subject client falls.

The seventh operation of the system aspect of the present invention is characterized by receiving any one or more of approval, rejection, and modification data from the at least one expert to generate expert judgement data.

The eight operation of the system aspect of the present invention is characterized by causing to present to the subject client the at least one item recommendation if it is determined in the preceding step that the at least one item recommendation of at least one size that suits the item of interest of the subject client is to be made consistent with the client specified data, the item properties data, and the expert judgement data.

In the system aspect of the present invention, and consistent with one or more exemplary, non-limiting implementations thereof, the aforementioned analysis of the retrieved item properties data comprises obtaining at least one tolerance value associated with the item of interest of the subject client and defined by the client specified data representing the range of acceptable values for each specification parameter.

In the system aspect of the present invention, and consistent with one or more exemplary, non-limiting implementations thereof, the at least one tolerance value defines a range of acceptable differences between a first measurement from the client specified data and a second measurement from the item properties data.

In the system aspect of the present invention, and consistent with one or more exemplary, non-limiting implementations thereof, a physical item corresponding to the at least one item recommendation has dimensional measurements that fall within the at least one tolerance value.

In the system aspect of the present invention, and consistent with one or more exemplary, non-limiting implementations thereof, the processor is caused to perform a further operation characterized by receiving from the subject client at least one selection of item recommendation from the at least one item recommendation.

In the system aspect of the present invention, and consistent with one or more exemplary, non-limiting implementations thereof, the processor is caused to perform a further operation characterized by receiving from the subject client an electronic purchase request for at least one physical item corresponding to the received selection.

In the system aspect of the present invention, and consistent with one or more exemplary, non-limiting implementations thereof, the processor is caused to perform a further operation characterized by initiating an electronic purchase transaction process based on the purchase request.

In the system aspect of the present invention, and consistent with one or more exemplary, non-limiting implementations thereof, the processor is caused to perform a further operation characterized by completing the electronic purchase transaction process by connecting to a payment gateway.

In the system aspect of the present invention, and consistent with one or more exemplary, non-limiting implementations thereof, the processor is caused to perform a further operation characterized by storing in a transaction history database the presented at least one item recommendation.

In the system aspect of the present invention, and consistent with one or more exemplary, non-limiting implementations thereof, the processor is caused to perform a further operation characterized by storing in a transaction history database implemented in the curation service-based framework the at least one item recommendation that is presented to the subject client.

Yet another aspect of the present invention is directed to a computer program product for providing at least one item recommendation within a computer-implemented curation service-based framework 30. The computer program product comprises a non-transitory computer readable medium that stores various sets of computer-executable instructions.

In the computer program aspect of the present invention, the item recommendation is for a subject client and is of at least one size that suits an item of interest of the subject client for which a plurality of sizes is available, the subject client belongs to at least one group of subject clients, and the at least one group of subject clients is part of a plurality of groups of subject clients.

The first set of instructions of the computer program product aspect of the present invention is characterized by receiving from the subject client an electronic request for item recommendations.

The second set of instructions of the computer program product aspect of the present invention is characterized by providing a set of specification parameters, each specification parameter in the set of specification parameters having a range of acceptable values.

The third set of instructions of the computer program product aspect of the present invention is characterized by receiving the range of acceptable values for each specification parameter, the range of values being processed as client specified data.

The fourth set of instructions of the computer program product aspect of the present invention is characterized by determining the at least one group of subject clients to which the subject client belongs to retrieve from an item properties database system implemented in the curation service-based framework 30 item properties data that are based on the client specified data.

The fifth set of instructions of the computer program product aspect of the present invention is characterized by analyzing the retrieved item properties data in connection with the client specified data to generate a filtered list of items with the plurality of sizes.

The sixth set of instructions of the computer program product aspect of the present invention is characterized by presenting the filtered list of items to at least one expert from a plurality of experts in the field under which the item of interest of the subject client falls.

The seventh set of instructions of the computer program product aspect of the present invention is characterized by receiving any one or more of approval, rejection, and modification data from the at least one expert to generate expert judgement data.

The eight set of instructions of the computer program product aspect of the present invention is characterized by, if it is determined in the preceding step that the at least one item recommendation of at least one size that suits the item of interest of the subject client is to be made consistent with the client specified data, the item properties data, and the expert judgement data, causing to present to the subject client the at least one item recommendation.

In the computer program product aspect of the present invention, and consistent with one or more exemplary, non-limiting implementations thereof, the analysis of the retrieved item properties data comprises obtaining at least one tolerance value associated with the item of interest of the subject client and defined by the client specified data representing the range of acceptable values for each specification parameter.

In the computer program product aspect of the present invention, and consistent with one or more exemplary, non-limiting implementations thereof, the at least one tolerance value defines a range of acceptable differences between a first measurement from the client specified data and a second measurement from the item properties data.

In the computer program product aspect of the present invention, and consistent with one or more exemplary, non-limiting implementations thereof, a physical item corresponding to the at least one item recommendation has dimensional measurements that fall within the at least one tolerance value.

In the computer program product aspect of the present invention, and consistent with one or more exemplary, non-limiting implementations thereof, the computer-executable instructions stored in the non-transitory computer readable medium are further characterized by receiving from the subject client at least one selection of item recommendation from the at least one item recommendation.

In the computer program product aspect of the present invention, and consistent with one or more exemplary, non-limiting implementations thereof, the computer-executable instructions stored in the non-transitory computer readable medium are further characterized by receiving from the subject client an electronic purchase request for at least one physical item corresponding to the received selection.

In the computer program product aspect of the present invention, and consistent with one or more exemplary, non-limiting implementations thereof, the computer-executable instructions stored in the non-transitory computer readable medium are further characterized by initiating an electronic purchase transaction process based on the purchase request.

In the computer program product aspect of the present invention, and consistent with one or more exemplary, non-limiting implementations thereof, the computer-executable instructions stored in the non-transitory computer readable medium are further characterized by completing the electronic purchase transaction process by connecting to a payment gateway.

In the computer program product aspect of the present invention, and consistent with one or more exemplary, non-limiting implementations thereof, the computer-executable instructions stored in the non-transitory computer readable medium are further characterized by storing in a transaction history database the presented at least one item recommendation.

In the computer program product aspect of the present invention, and consistent with one or more exemplary, non-limiting implementations thereof, the computer-executable instructions stored in the non-transitory computer readable medium are further characterized by storing in a transaction history database implemented in the curation service-based framework 30 the at least one item recommendation that is presented to the subject client.

A further aspect of the present invention is directed to an intermediate system for providing at least one item recommendation within a computer-implemented curation service-based framework 30.

The intermediate system is coupled to a network that couples a source of a data structure implemented in the curation service-based framework and a recipient computer. The intermediate system comprises a memory unit and a control sub-system that is arranged to execute various computer executable codes embodied and stored in the memory unit.

In the intermediate system aspect of the present invention, the item recommendation is for a subject client and is of at least one size that suits an item of interest of the subject client for which a plurality of sizes is available, the subject client belongs to at least one group of subject clients, and the at least one group of subject clients is part of a plurality of groups of subject clients.

Using the computer-executable codes, the control sub-system is arranged to: (a) receive from the subject client an electronic request for item recommendations; (b) provide a set of specification parameters, each specification parameter in the set of specification parameters having a range of acceptable values; (c) receive the range of acceptable values for each specification parameter, the range of values being processed as client specified data; (d) determine the at least one group of subject clients to which the subject client belongs to retrieve from an item properties database system implemented in the curation service-based framework item 30 properties data that are based on the client specified data; (e) analyze the retrieved item properties data in connection with the client specified data to generate a filtered list of items with the plurality of sizes; (f) present the filtered list of items to at least one expert from a plurality of experts in the field under which the item of interest of the subject client falls; (g) receive any one or more of approval, rejection, and modification data from the at least one expert to generate expert judgement data; and (h) if it is determined in the preceding step that the at least one item recommendation of at least one size that suits the item of interest of the subject client is to be made consistent with the client specified data, the item properties data, and the expert judgement data, cause to present to the subject client the at least one item recommendation.

A further system comprising multiple further intermediate systems is also disclosed. Each further intermediate system of the multiple further intermediate systems includes a further memory unit and a further control sub-system that that is arranged to execute various further computer executable codes embodied and stored in the further memory unit.

In the further system aspect of the present invention, the item recommendation is for a subject client and is of at least one size that suits an item of interest of the subject client for which a plurality of sizes is available, the subject client belongs to at least one group of subject clients, and the at least one group of subject clients is part of a plurality of groups of subject clients.

Using the further computer-executable codes, the further control sub-system is arranged to: (a) receive from the subject client an electronic request for item recommendations; (b) provide a set of specification parameters, each specification parameter in the set of specification parameters having a range of acceptable values; (c) receive the range of acceptable values for each specification parameter, the range of values being processed as client specified data; (d) determine the at least one group of subject clients to which the subject client belongs to retrieve from an item properties database system implemented in the curation service-based framework 30 item properties data that are based on the client specified data; (e) analyze the retrieved item properties data in connection with the client specified data to generate a filtered list of items with the plurality of sizes; (f) present the filtered list of items to at least one expert from a plurality of experts in the field under which the item of interest of the subject client falls; (g) receive any one or more of approval, rejection, and modification data from the at least one expert to generate expert judgement data; and (h) if it is determined in the preceding step that the at least one item recommendation of at least one size that suits the item of interest of the subject client is to be made consistent with the client specified data, the item properties data, and the expert judgement data, cause to present to the subject client the at least one item recommendation.

In the intermediate system and further system aspects of the present invention, and consistent with one or more exemplary, non-limiting implementations thereof, the analysis of the retrieved item properties data comprises obtaining at least one tolerance value associated with the item of interest of the subject client and defined by the client specified data representing the range of acceptable values for each specification parameter.

In the intermediate system and further system aspects of the present invention, and consistent with one or more exemplary, non-limiting implementations thereof, the at least one tolerance value defines a range of acceptable differences between a first measurement from the client specified data and a second measurement from the item properties data.

In the intermediate system and further system aspects of the present invention, and consistent with one or more exemplary, non-limiting implementations thereof, a physical item corresponding to the at least one item recommendation has dimensional measurements that fall within the at least one tolerance value.

In the intermediate system and further system aspects of the present invention, and consistent with one or more exemplary, non-limiting implementations thereof, each of control sub-system and the further control sub-system is further arranged to receive from the subject client at least one selection of item recommendation from the at least one item recommendation.

In the intermediate system and further system aspects of the present invention, and consistent with one or more exemplary, non-limiting implementations thereof, each of control sub-system and the further control sub-system is further arranged to receive from the subject client an electronic purchase request for at least one physical item corresponding to the received selection.

In the intermediate system and further system aspects of the present invention, and consistent with one or more exemplary, non-limiting implementations thereof, each of control sub-system and the further control sub-system is further arranged to initiate an electronic purchase transaction process based on the purchase request.

In the intermediate system and further system aspects of the present invention, and consistent with one or more exemplary, non-limiting implementations thereof, each of control sub-system and the further control sub-system is further arranged to complete the electronic purchase transaction process by connecting to a payment gateway.

In the intermediate system and further system aspects of the present invention, and consistent with one or more exemplary, non-limiting implementations thereof, each of control sub-system and the further control sub-system is further arranged to store in a transaction history database the presented at least one item recommendation.

In the intermediate system and further system aspects of the present invention, and consistent with one or more exemplary, non-limiting implementations thereof, each of control sub-system and the further control sub-system is further arranged to store in a transaction history database implemented in the curation service-based framework the at least one item recommendation that is presented to the subject client.

In system where item recommendations are for a subject client and are of at least one size that suits an item of interest of the subject client for which a plurality of sizes is available, where the subject client belongs to at least one group of subject clients, and where the at least one group of subject clients is part of a plurality of groups of subject clients, a further aspect of the present invention is directed to a data stream which is representative of a computer program having instructions which when executed by a processor component cause the processor component to perform computer-executable tasks.

The first task of the data stream aspect of the present invention is characterized by receiving from the subject client an electronic request for item recommendations.

The second task of the data stream aspect of the present invention is characterized by providing a set of specification parameters, each specification parameter in the set of specification parameters having a range of acceptable values.

The third task of the data stream aspect of the present invention is characterized by receiving the range of acceptable values for each specification parameter, the range of values being processed as client specified data.

The fourth task of the data stream aspect of the present invention is characterized by determining the at least one group of subject clients to which the subject client belongs to retrieve from an item properties database system implemented in the curation service-based framework 30 item properties data that are based on the client specified data.

The fifth task of the data stream aspect of the present invention is characterized by analyzing the retrieved item properties data in connection with the client specified data to generate a filtered list of items with the plurality of sizes.

The sixth task of the data stream aspect of the present invention is characterized by presenting the filtered list of items to at least one expert from a plurality of experts in the field under which the item of interest of the subject client falls.

The seventh task of the data stream aspect of the present invention is characterized by receiving any one or more of approval, rejection, and modification data from the at least one expert to generate expert judgement data.

The eight task of the data stream aspect of the present invention is characterized by causing to present to the subject client the at least one item recommendation if it is determined in the preceding step that the at least one item recommendation of at least one size that suits the item of interest of the subject client is to be made consistent with the client specified data, the item properties data, and the expert judgement data.

In the data stream aspect of the present invention, and consistent with one or more exemplary, non-limiting implementations thereof, the analysis of the retrieved item properties data comprises obtaining at least one tolerance value associated with the item of interest of the subject client and defined by the client specified data representing the range of acceptable values for each specification parameter.

In the data stream aspect of the present invention, and consistent with one or more exemplary, non-limiting implementations thereof, the at least one tolerance value defines a range of acceptable differences between a first measurement from the client specified data and a second measurement from the item properties data.

In the data stream aspect of the present invention, and consistent with one or more exemplary, non-limiting implementations thereof, a physical item corresponding to the at least one item recommendation has dimensional measurements that fall within the at least one tolerance value.

In the data stream aspect of the present invention, and consistent with one or more exemplary, non-limiting implementations thereof, the processor is further caused to perform a task characterized by receiving from the subject client at least one selection of item recommendation from the at least one item recommendation.

In the data stream aspect of the present invention, and consistent with one or more exemplary, non-limiting implementations thereof, the processor is further caused to perform a task characterized by receiving from the subject client an electronic purchase request for at least one physical item corresponding to the received selection.

In the data stream aspect of the present invention, and consistent with one or more exemplary, non-limiting implementations thereof, the processor is further caused to perform a task characterized by initiating an electronic purchase transaction process based on the purchase request.

In the data stream aspect of the present invention, and consistent with one or more exemplary, non-limiting implementations thereof, the processor is further caused to perform a task characterized by completing the electronic purchase transaction process by connecting to a payment gateway.

In the data stream aspect of the present invention, and consistent with one or more exemplary, non-limiting implementations thereof, the processor is further caused to perform a task characterized by storing in a transaction history database the presented at least one item recommendation.

In the data stream aspect of the present invention, and consistent with one or more exemplary, non-limiting implementations thereof, the processor is further caused to perform a task characterized by storing in a transaction history database implemented in the curation service-based framework the at least one item recommendation that is presented to the subject client.

Still a further aspect of the present invention is directed to a data structure for holding a set of information that is transmitted from the client computing device to the curation service-based framework over the data communications network and that is used to process by one or more processors data stored in a memory unit. The data structure aspect of the present invention is for use in providing at least one item recommendation within the computer-implemented curation service-based framework, wherein the item recommendation is for a subject client and is of at least one size that suits an item of interest of the subject client for which a plurality of sizes is available, wherein the subject client belongs to at least one group of subject clients, and wherein the at least one group of subject clients is part of a plurality of groups of subject clients.

Consistent with one or more other aspects and disclosed implementations of the present invention, the data structure comprises various fields.

The first field of the data structure aspect of the present invention is for holding information associated with receiving from the subject client an electronic request for item recommendations.

The second field of the data structure aspect of the present invention is for holding information associated with providing a set of specification parameters, each specification parameter in the set of specification parameters having a range of acceptable values.

The third field of the data structure aspect of the present invention is for holding information associated with receiving the range of acceptable values for each specification parameter, the range of values being processed as client specified data.

The fourth field of the data structure aspect of the present invention is for holding information associated with determining the at least one group of subject clients to which the subject client belongs to retrieve from an item properties database system implemented in the curation service-based framework item properties data that are based on the client specified data.

The fifth field of the data structure aspect of the present invention is for holding information associated with analyzing the retrieved item properties data in connection with the client specified data to generate a filtered list of items with the plurality of sizes.

The sixth field of the data structure aspect of the present invention is for holding information associated with presenting the filtered list of items to at least one expert from a plurality of experts in the field under which the item of interest of the subject client falls.

The seventh field of the data structure aspect of the present invention is for holding information associated with receiving any one or more of approval, rejection, and modification data from the at least one expert to generate expert judgement data.

The eight field of the data structure aspect of the present invention is for holding information associated with causing to present to the subject client the at least one item recommendation if it is determined in the preceding step that the at least one item recommendation of at least one size that suits the item of interest of the subject client is to be made consistent with the client specified data, the item properties data, and the expert judgement data.

In the data structure aspect of the present invention, and consistent with one or more exemplary, non-limiting implementations thereof, the analysis of the retrieved item properties data comprises obtaining at least one tolerance value associated with the item of interest of the subject client and defined by the client specified data representing the range of acceptable values for each specification parameter.

In the data structure aspect of the present invention, and consistent with one or more exemplary, non-limiting implementations thereof, the at least one tolerance value defines a range of acceptable differences between a first measurement from the client specified data and a second measurement from the item properties data.

In the data structure aspect of the present invention, and consistent with one or more exemplary, non-limiting implementations thereof, a physical item corresponding to the at least one item recommendation has dimensional measurements that fall within the at least one tolerance value.

In the data structure aspect of the present invention, and consistent with one or more exemplary, non-limiting implementations thereof, another field of the data structure aspect of the present invention is for holding information associated with receiving from the subject client at least one selection of item recommendation from the at least one item recommendation.

In the data structure aspect of the present invention, and consistent with one or more exemplary, non-limiting implementations thereof, another field of the data structure aspect of the present invention is for holding information associated with receiving from the subject client an electronic purchase request for at least one physical item corresponding to the received selection.

In the data structure aspect of the present invention, and consistent with one or more exemplary, non-limiting implementations thereof, another field of the data structure aspect of the present invention is for holding information associated with initiating an electronic purchase transaction process based on the purchase request.

In the data structure aspect of the present invention, and consistent with one or more exemplary, non-limiting implementations thereof, another field of the data structure aspect of the present invention is for holding information associated with completing the electronic purchase transaction process by connecting to a payment gateway.

In the data structure aspect of the present invention, and consistent with one or more exemplary, non-limiting implementations thereof, another field of the data structure aspect of the present invention is for holding information associated with storing in a transaction history database the presented at least one item recommendation.

In the data structure aspect of the present invention, and consistent with one or more exemplary, non-limiting implementations thereof, another field of the data structure aspect of the present invention is for holding information associated with storing in a transaction history database implemented in the curation service-based framework the at least one item recommendation that is presented to the subject client.

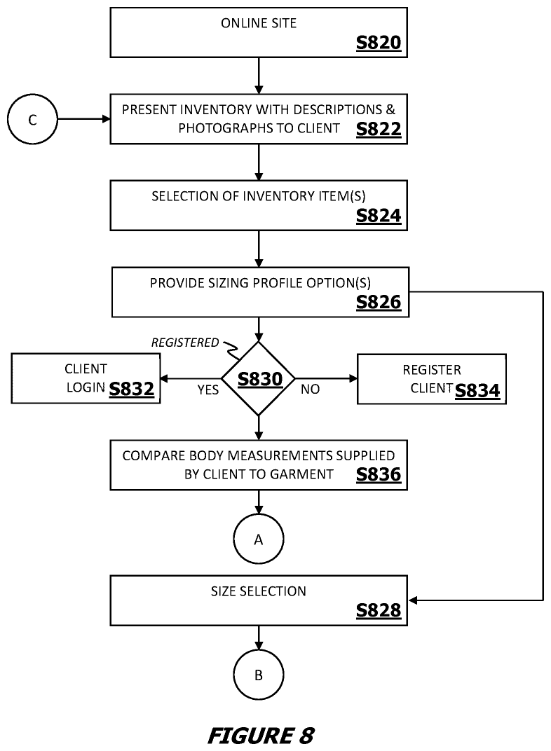

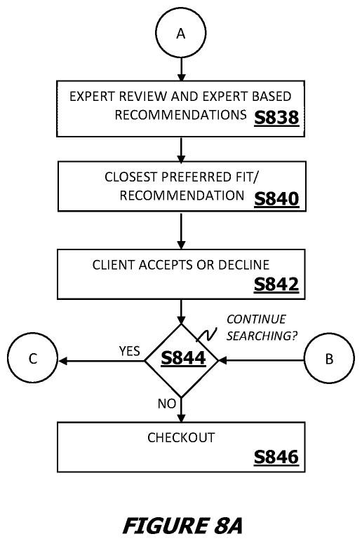

Referring now to FIGS. 8 and 8A, there shown connected flow diagrams showing an example manner of using the curation service-based framework 30 by a subject client in accordance with one or more aspects and implementations of the present invention. A subject client logs onto the Internet and selects or searches for a host or vendor website to shop online (S820). Online shopping may be performed remotely by the subject client. For example, the subject client may be able to place the order from home or another locale without actually visiting the host or vendor's brick and mortar store. Additionally, one or more online shopping computers or kiosks may be installed on the premises of the brick and mortar store to allow the client to locate and purchase fashion and styling items missing from or otherwise not in inventory at the store. The presence of online shopping computers or kiosks available in a store may be particularly useful during busy shopping times when the in-store clients outnumber the salespersons. Instead of waiting impatiently for a salesperson to become available to render the required service, the in-store client can obtain automated assistance at the kiosk or terminal.

The host's or vendor's inventory may be stored in a database and may be presented to the subject client via a web browser (S822). This inventory may be organized by, by way of examples, categories, such as by gender (e.g., men, women, boys, girls) and apparel group (e.g., pants, shirts, dresses, suits, skirts, blouses, shorts, etc.). It is to be understood and appreciated that other category descriptors may be used, such as apparel style, e.g., formal, casual, etc., or special sizing, e.g., big and tall.

The subject client searching the inventory at the host's website may be able to select a garment item for online purchase (S824). Consequently, a sizing profile option is automatically made available to the subject client (S826). Optionally, the subject client may decline the sizing profile option and proceed with an unassisted size selection of the garment (S828) and decide whether or not to continue shopping (S844). Alternatively, the subject client may select to inquire about a recommended standard fit size of the selected garment.

The subject client may then be prompted to identify whether the he or she as an end user is new client or a previously registered client (S830). If the end user is already registered then the subject client logs in (S832). Log in may be accomplished by entering the end user's log-in name or other personal information sufficient to identify the end user from the database. Account information, including confidential body measurements and billing information, may not be accessible to the subject client unless the client enters the password. If the end user is not registered, the online client/end user is taken through the registration process (S834). These steps may be bypassed if the subject client has already registered and logged in, e.g., prior to garment selection or while previously selecting another garment, whichever is the pre-configured arrangement in the herein disclosed curation service-based framework 30 of the present invention.

The body measurements of the individual garment end user are compared to the design specifications of the standard fit sizes of the selected garment (S836). The evaluation of whether or not a certain garment size is appropriate for an end user may be carried out by comparing the end user's body measurements to the corresponding design specifications or the item properties of the selected garment. Tolerance with respect to one or more of the predetermined and/or adjustable design specifications may be applied may be considered in such comparison. In this regard, the design specifications may be weighted relative to one another by importance of fit. The preferred fit data, as may be used herein, may be added to such comparison data in accordance with one or more implementations of the present invention.

In an implementation, the subject client may be presented with a virtual image of the end user wearing the garment in the selected size. For example, in some preferred implementations of the present invention, the selected fit size garment may be superimposed over a body image of the end user to simulate physically how the garment would drape on the end user. The body image may be proportioned to correspond to the end user's body measurements. The virtual image presentation may be automatically performed by the computer system and viewable on a monitor display. Optionally, and in an implementation, the virtual image may also include other characteristics of the subject client, such as a digital representation or photograph of the end user's face.

The item recommendation, or each of the item recommendations as the case may be, may then be reviewed by one or more experts or professionals (S838) wherein closest preferred fit or any similar item recommendation may be provided (S840). Group preferences with similar measurements may also be considered in this regard and relative to the client preferred data. Optionally, the subject client may be prompted to accept or decline the size selection based on the final recommendation or the closest preferred fit (S842), or select or choose another size of his or her choosing which may be based on the closest preferred fit recommendation. Optionally, in an implementation, the subject client is provided with the capability to modify the virtual image or set of images to reflect the end user's “target” body measurements. In this manner, the subject client is able to determine how the garment will fit after he or she has completed his or her diet or body shaping program.

At consequent decision step (S844), the subject client may select to continue shopping. The client continues shopping, the client may be returned to the inventory listing at step S822 in the flow diagram. Otherwise, if the shopping session is complete, the subject client may proceed to checkout (S846) if a checkout means is provided in the curation service-based framework 30.

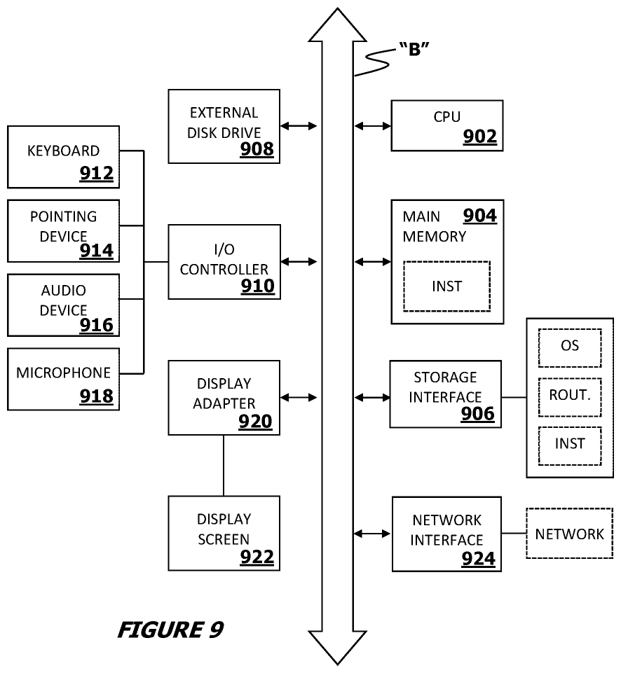

FIG. 9 shows a schematic block diagram which illustrates exemplary hardware and software components of the curation service-based framework 30 of the present invention. The curation service-based framework may include a system bus “B” that enables communication of the following components: a processor 902 which may be a CPU (central processing unit), a memory system 904 containing computer-executable instructions, a storage interface 906 for storing an operating system, routines, and the instructions, among others, an external disk drive 908, an input/output controller 910 which may be connected to a keyboard 912, a pointing device 914, an audio device 916, and a microphone 918, a display adapter 920 connected to the display screen 922, and a network interface 924 for enabling data communication with other devices over any suitable communication network which may be an Internet Protocol (IP) based data communication network or the “Internet.”

Although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a product may be described as including a plurality of components, aspects, qualities, characteristics and/or features, that does not indicate that all of the plurality are essential or required. Various other embodiments within the scope of the described invention(s) include other products that omit some or all of the described plurality. Furthermore, an enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise.

While the present disclosure includes several variations described in detail, various modifications and improvements thereon will become readily apparent to those skilled in the art. Accordingly, the spirit and scope of the present invention is not to be limited by the foregoing examples, but is to be understood in the broadest sense allowable by relevant laws and rules.

Further, and where applicable, the scope of the present invention is shown by the following or accompanying claims rather than the above description which is illustrative in nature, and all changes or modifications derived from the meaning and scope of the claims and their equivalents should be construed as being included in the scope of the present invention.

1. A method of providing at least one item recommendation within a computer-implemented curation service-based framework, the item recommendation being for a subject client and being of at least one size that suits an item of interest of the subject client for which a plurality of sizes is available, the subject client belonging to at least one group of subject clients, the at least one group of subject clients being part of a plurality of groups of subject clients, the method comprising the steps of:
receiving from the subject client an electronic request for item recommendations;
providing a set of specification parameters, each specification parameter in the set of specification parameters having a range of acceptable values;
receiving the range of acceptable values for each specification parameter, the range of values being processed as client specified data;
determining the at least one group of subject clients to which the subject client belongs to retrieve from an item properties database system implemented in the curation service-based framework item properties data that are based on the client specified data;
analyzing the retrieved item properties data in connection with the client specified data to generate a filtered list of items with the plurality of sizes;
presenting the filtered list of items to at least one expert from a plurality of experts in the field under which the item of interest of the subject client falls;
receiving any one or more of approval, rejection, and modification data from the at least one expert to generate expert judgement data; and
if it is determined in the preceding step that the at least one item recommendation of at least one size that suits the item of interest of the subject client is to be made consistent with the client specified data, the item properties data, and the expert judgement data, causing to present to the subject client the at least one item recommendation.

2. The method according to claim 1, wherein the analyzing step comprises obtaining at least one tolerance value associated with the item of interest of the subject client and defined by the client specified data representing the range of acceptable values for each specification parameter.

3. The method according to claim 2, wherein the at least one tolerance value defines a range of acceptable differences between a first measurement from the client specified data and a second measurement from the item properties data.

4. The method according to claim 2 or 3, wherein a physical item corresponding to the at least one item recommendation has dimensional measurements that fall within the at least one tolerance value.

5. The method according to claim 1, further comprising receiving from the subject client at least one selection of item recommendation from the at least one item recommendation.

6. The method according to claim 5, further comprising receiving from the subject client an electronic purchase request for at least one physical item corresponding to the received selection.

7. The method according to claim 6, further comprising initiating an electronic purchase transaction process based on the purchase request.

8. The method according to claim 7, further comprising completing the electronic purchase transaction process by connecting to a payment gateway.

9. The method according to claim 1, further comprising storing in a transaction history database the presented at least one item recommendation.

10. The method according to claim 9, further comprising storing in a transaction history database implemented in the curation service-based framework the at least one item recommendation that is presented to the subject client.

11. A system for providing at least one item recommendation within a computer-implemented curation service-based framework, the item recommendation being for a subject client and being of at least one size that suits an item of interest of the subject client for which a plurality of sizes is available, the subject client belonging to at least one group of subject clients, the at least one group of subject clients being part of a plurality of groups of subject clients, the system comprising a processor and a tangible, non-transitory memory configured to communicate with the processor, the tangible, non-transitory memory having instructions stored thereon that, in response to execution by the processor, cause the processor to perform:
receiving from the subject client an electronic request for item recommendations;
providing a set of specification parameters, each specification parameter in the set of specification parameters having a range of acceptable values;
receiving the range of acceptable values for each specification parameter, the range of values being processed as client specified data;
determining the at least one group of subject clients to which the subject client belongs to retrieve from an item properties database system implemented in the curation service-based framework item properties data that are based on the client specified data;
analyzing the retrieved item properties data in connection with the client specified data to generate a filtered list of items with the plurality of sizes;
presenting the filtered list of items to at least one expert from a plurality of experts in the field under which the item of interest of the subject client falls;
receiving any one or more of approval, rejection, and modification data from the at least one expert to generate expert judgement data; and
if it is determined in the preceding step that the at least one item recommendation of at least one size that suits the item of interest of the subject client is to be made consistent with the client specified data, the item properties data, and the expert judgement data, causing to present to the subject client the at least one item recommendation.
